(19) United States
(12) Patent Application Publication
(10) Pub. No.: US 2011/0062715 A1
(43) Pub. Date: Mar. 17, 2011

(54) SUBMERSIBLE HYDROELECTRIC POWER GENERATOR AND METHODS THEREOF

(76) Inventor: PAUL DIMAGGIO, East Brunswick, NJ (US)

(21) Appl. No.: 12/881,706

(22) Filed: Sep. 14, 2010

Related U.S. Application Data
(60) Provisional application No. 61/242,043, filed on Sep. 14, 2009.

(51) Int. Cl. F03B 13/10

(52) U.S. Cl. 290/54

(57) ABSTRACT

Embodiments of the present invention relate to an apparatus for generating usable electric power by harnessing continuous water flow from a river, stream or ocean and efficiently and perpetually generating electric energy therefrom. In one embodiment, a submersible hydroelectric power generator comprises a frame structure supporting a continuous track, a plurality of fins, each fin rotatably connected to the track about a bottom edge of the fin, a power generator in communication with the track, the power generator for converting rotational mechanical energy to electrical energy, wherein each of the plurality of fins are in an open position when the fin is passing along the continuous track over a front and a top portion of the frame structure, and wherein each of the plurality of fins are in a closed position when the fin is passing along the continuous track over a rear and bottom portion of the frame structure.

### CROSS-REFERENCE TO RELATED APPLICATIONS

This application claims priority to pending U.S. Provisional Patent Application Ser. No. 61/242,043, filed Sep. 14, 2009, entitled “Hydroelectric Power Generator and Methods Thereof,” the disclosure of which is incorporated by reference herein in its entirety.

### BACKGROUND

1. Field of the Invention

Embodiments of the present invention generally relate to a submersible hydroelectric power generator and methods thereof. More specifically, embodiments of the present invention relate to an apparatus for generating usable electric power by harnessing continuous tidal and current flow from a lake, river, stream or ocean and efficiently and perpetually generating electric energy therefrom.

2. Description of Related Art

The concept of harnessing energy from natural water flow has been practiced for centuries. These known methods of harnessing the kinetic energy present in any moving body of water range from a water or paddle wheel for powering old mills, all the way to large scale municipal projects involving the construction of dams and other structures to funnel water through turbines. Regardless of design, the general principle of these known systems involve converting water flow, either gravity or tidal driven, as an energy source.

In more recent advancements, a variety of improved paddlewheel style designs have been suggested for generating electricity from water power. A significant problem with paddlewheel designs is the lack of applicability underwater, e.g., on or near the ocean floor. Given the symmetry of the design of a paddlewheel, the force from a current flow on a top blade in a first direction, is substantially the same force in the same first direction on a bottom—thus, leaving the paddlewheel motionless.

Similarly, a variety of rotary generation devices utilizing a propeller or turbine style blades have been contemplated for the generation of hydroelectric power. A major problem with these types of systems in underwater applications is the complete decimation of marine life downstream. By its very design, the rotary generation device creates intense turbulent flow which destroys coral reefs, marine life habitats, and eventually causes sand bed or ocean floor erosion.

Although most energy in the United States is produced by fossil-fuel and nuclear power plants, hydroelectricity is still important to the nation, as about 7 percent of total power is produced by hydroelectric plants. Unfortunately, much of the hydroelectric power is obtained through the use of dams, which can have drastic environmental effects through either the creation of a new dam (i.e., blockage of existing water sources) or destruction of old dams (i.e., potential flooding downstream).

Outside of the United States hydroelectricity represents approximately 19% of total world electricity production. According to recent studies, approximately two-thirds of the economically feasible potential remains to be developed, with a significant portion of untapped hydroelectric resources being abundant in Latin America, Central Africa, India and China.

While known solutions have suggested various improvements to traditional hydroelectric generation devices, there remains a need for an improved hydroelectric power generator suitable for underwater applications and methods thereof while overcoming the shortcomings of existing devices.

### SUMMARY

Embodiments of the present invention generally relate to a submersible hydroelectric power generator and methods thereof. More specifically, embodiments of the present invention relate to an apparatus for generating usable electric power by harnessing continuous tidal and current flow from a lake, river, stream or ocean and efficiently and perpetually generating electric energy therefrom.

In one embodiment of the present invention, a submersible hydroelectric power generator comprises a frame structure supporting a continuous track, a plurality of fins, each fin rotatably connected to the track about a bottom edge of the fin, a power generator in communication with the track, the power generator for converting rotational mechanical energy to electrical energy, wherein each of the plurality of fins are in an open position when the fin is passing along the continuous track over a front and a top portion of the frame structure, and wherein each of the plurality of fins are in a closed position when the fin is passing along the continuous track over a rear and bottom portion of the frame structure.

In another embodiment of the present invention, a power system comprises a source of continuously moving water, a submersible hydroelectric power generator comprising a frame structure supporting a continuous track, a plurality of fins, each fin rotatably connected to the track about a bottom edge of the fin, a power generator in communication with the track, the power generator for converting rotational mechanical energy to electrical energy, wherein each of the plurality of fins are in an open position when the fin is passing along the continuous track over a front and a top portion of the frame structure, and wherein each of the plurality of fins are in a closed position when the fin is passing along the continuous track over a rear and bottom portion of the frame structure, and a power consumption entity.

In yet another embodiment of the present invention, a method of generating hydroelectric power comprises providing a submersible hydroelectric power generator, the submersible hydroelectric power generator comprising: a frame structure supporting a continuous track, a plurality of fins, each fin rotatably connected to the track about a bottom edge of the fin, a power generator in communication with the track, the power generator for converting rotational mechanical energy to electrical energy, wherein each of the plurality of fins are in an open position when the fin is passing along the continuous track over a front and a top portion of the frame structure, and wherein each of the plurality of fins are in a closed position when the fin is passing along the continuous track over a rear and bottom portion of the frame structure; placing the submersible hydroelectric power generator in a source of continuously moving water, wherein the front of the frame structure is facing towards the direction of the continuously moving water; generating electrical energy from the rotational mechanical energy of the track; and distributing the electrical energy to a power consumption entity.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a perspective view of a submersible hydroelectric power generator in accordance with one embodiment of the present invention;

FIG. 2 depicts a top view of a submersible hydroelectric power generator in accordance with one embodiment of the present invention;

FIG. 3 depicts a perspective view of a fin for use in a submersible hydroelectric power generator in accordance with one embodiment of the present invention;

FIG. 4 depicts a side view of a fin for use in a submersible hydroelectric power generator in accordance with one embodiment of the present invention;

FIG. 5 depicts a side view of a hydroelectric power system in accordance with one embodiment of the present invention; and

FIG. 6 depicts a flowchart of a method of generating hydroelectric energy in accordance with one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

In the following detailed description, numerous specific details are set forth in order to provide a thorough understanding of exemplary embodiments or other examples described herein. However, it will be understood that these examples may be practiced without the specific details. In other instances, well-known methods, procedures, and components have not been described in detail, so as to not obscure the following description. Furthermore, the examples disclosed herein are for exemplary purposes only and other examples may be employed in lieu of, or in combination with, the examples disclosed.

Embodiments of the present invention generally relate to a submersible hydroelectric power generator and methods thereof. More specifically, embodiments of the present invention relate to an apparatus for generating usable and/or storable electrical energy by harnessing continuous tidal and/or current flow from a lake, river, stream or ocean and efficiently and perpetually generating electrical energy therefrom.

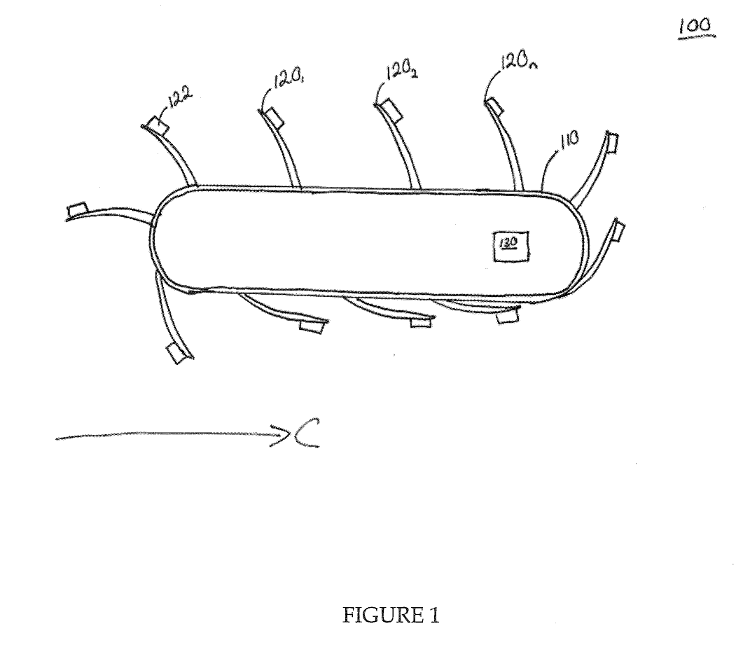

FIG. 1 depicts a perspective view of a submersible hydroelectric power generator in accordance with one embodiment of the present invention. Generally, a hydroelectric power generator 100 comprises a frame structure for supporting a continuous track 110, a plurality of fins (or protruded airfoils) 120₁₋ₙ, and a power generator 130 for converting mechanical energy into electrical energy, in accordance with embodiments of the present invention. In many embodiments, the hydroelectric power generator 100 is intended to be placed underwater into a continuous tidal or current flow from a lake, river, stream or ocean, as designated by current C.

The frame structure for supporting the continuous track 110 comprises any type of frame structure suitable for embodiments of the present invention to maintain the general positioning and optional housing of the hydroelectric power generator 100. In one embodiment, the frame structure incorporates a pair of opposing track rails that make up a portion of the continuous track 110. In yet another embodiment, the frame structure 110 comprises a housing structure for supporting at least the continuous track 110, the plurality of fins 120₁₋ₙ and the generator 130. A more detailed description of certain embodiments of the frame structure is provided herein.

It should be appreciated, embodiments of the present invention are designed to be utilized either as a self-standing/floating apparatus or as engaged with a floating device, such as a barge. In the first instance, the hydroelectric power generator 100 may be anchored or tethered to the ocean, lake or river floor by any means suitable. Optionally, in such an embodiment, the means for anchoring allows for rotational movement of the hydroelectric power generator 100, such that the device may always be capable of aligning itself with the direction of the current.

In certain embodiments, whereby the hydroelectric power generator 100 is engaged with a floating device, such as a barge, the hydroelectric power generator 100 may be positioned in any direction the barge faces—which is usually the direction of the current. However, when the barge is in motion, either through self-propelled means or through tow, the hydroelectric power generator 100 may be facing the towards direction of movement, in which instance the relative motion of the water flow will remain the proper direction of the hydroelectric power generator 100 for operation.

The continuous track 110 may comprise any type track suitable for embodiments of the present invention. In one embodiment, the continuous track 110 comprises a loop of rigid material (e.g., connected metal plates, chain, rope, etc.) capable of supporting the forces endured when the hydroelectric power generator 100 is in operation. In many embodiments, the continuous track 110 is also provided to engage the plurality of fins 120. A more detailed description of embodiments of the continuous track is provided herein.

The generator 130 may comprise any type of power generator capable of converting mechanical energy to an alternate form of energy suitable for embodiments of the present invention. In one embodiment, the generator 130 comprises an electrical generator for converting rotational mechanical energy to electrical energy using electromagnetic induction, or similar means to convert the forms of energy. Alternative embodiments of the present invention may employ any other type of power converter or storage apparatus, as such devices are well known in the industry.

The generator 130 is generally positioned integrally with the frame support, although in certain embodiment, may merely be mechanically engaged therewith. In one embodiment, the generator 130 comprises a shaft, gear or other rotatable structure engaged with the plurality of fins 120₁₋ₙ, for example, with a continuous track 110 connecting each of the fins 120₁₋ₙ. Thus, as the fins 120₁₋ₙ move about a path defined by the continuous track 110, a rotational movement is imparted to the rotatable structure of the generator 130. In turn, the generator 130 converts such rotational movement to electrical energy that may either be immediately harnessed in a remote application or stored for later use.

The fins 120₁₋ₙ (hereinafter collectively referred to as “fins 120”) each comprise an airfoil, rotatably connected on a first end to at least a portion of the track 110 of the frame support. In many embodiments, all of the fins 120 are interconnected with a belt or chain-type connection means within the track. In such an embodiment, any movement of one fin requires movement of all fins about the track, in an equidistant motion.

The fins 120 generally serve to engage the current or tidal flow of the water as it passes over the submersible hydroelectric power generator 100. In many instances, as water current approaches the hydroelectric power generator 100, a front fin engages a volume of water, flowing at a particular volumetric flow rate (e.g., 100 cu.ft./sec.). As soon at the volume of water hits a surface of the front fin, an immediate force is applied to the fin. In accordance with embodiments of the present invention, once such force reaches a threshold value, which may occur almost instantaneously upon the slightest measurable force, the fin is forced to move in the direction of the current, clockwise about the continuous track.

Because the fins 120 are interconnected, in many embodiments, as soon as the front fin moves clockwise about the continuous track 110, all of the fins 120 move clockwise about the continuous track 110. Once the front fin is moved a sufficient distance, generally equal to about the distance between fins 120 within the hydroelectric power generator 100, a subsequent fin is then in position to become the front fin, and the cycle continues.

As discussed supra, the fins 120 are generally rotatable about a first end connected with the track of the frame support 110. In most embodiments, the rotation of the fins 120 is limited to between positions of about 0 degrees to about 90 degrees rotation. In such embodiments, the rotation of the fins 120 may be stopped at 90 degrees by mechanical stops, braces, or the like, affixed to a back side of the fins 120. The fins may be closed, to its zero degree position, by virtue of the continuous track 110.

In some embodiments, the fins 120 are optionally provided with floatation devices 122, affixed to a top back portion of the fins 120. The floatation devices 122 may comprise any material suitable for embodiments of the present invention and capable of facilitating the extension of the front fin to a position substantially close to a 90 degree position at the earliest reasonable opportunity. By doing so, the front fin is capable of engaging the water current on its front surface and being the primary driving fin of the submersible hydroelectric power generator 100. Similarly, as the fins move around the back side of the hydroelectric power generator 100, the floatation device 122 may assist in the closing of the fin to a zero degree position, substantially parallel or flat against a bottom portion of the continuous track 110.

It should be appreciated that components of the hydroelectric power generator 100 may comprise any size suitable for embodiments of the present invention. In certain embodiments, the hydroelectric power generator 100 may be adapted for an industrial scale, such that it may comprise a length up to about a quarter mile or longer, having hundreds or thousands of fins thereon. In another embodiment, the hydroelectric power generator 100 may be adapted for use in a personal residence located on a river or stream, and may be between about eight to about 20 feet long, having between ten to twenty fins thereon. In yet another embodiment, the hydroelectric power generator 100 may be adapted for use with a decorative water fountain having a slight current therewith. In such an embodiment, the hydroelectric power generator 100 may be on the order of inches long, with a few fins thereon.

The materials utilized for each of the components of the hydroelectric power generator 100 may comprise any non-corrosive materials suitable for embodiments of the present invention. In one embodiment, the materials utilized as the components of the hydroelectric power generator 100 comprise at least one of a non-corrosive or low-corrosion metal, such as stainless steel, zinc, titanium, magnesium, cadmium, graphite, or the like. Alternatively, the materials utilized as the components of the hydroelectric power generator 100 may comprise a polymer such as polystyrene, poly(methyl) methacrylate, polycarbonate, polyethylene, polypropylene, poly(vinyl chloride), carbon fiber, nylon, polyisoprene, polybutadiene, polyisobutylene or the like.

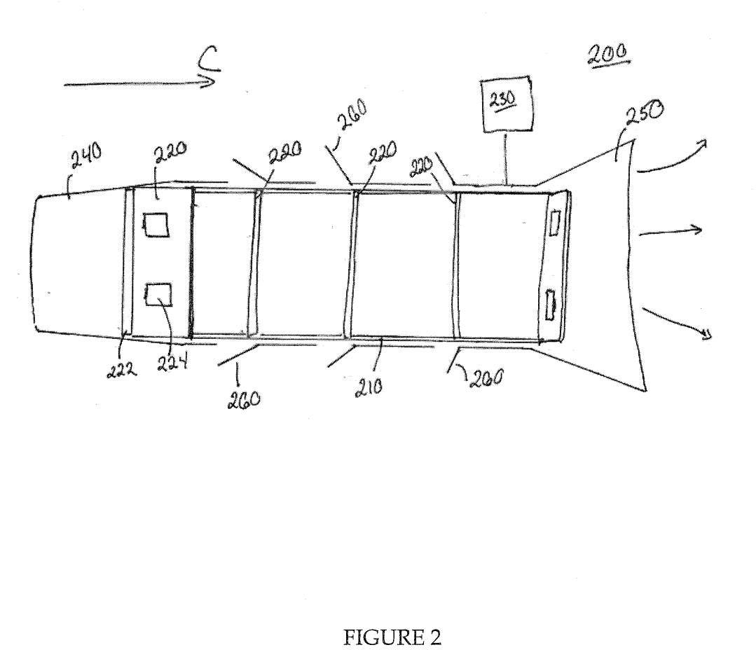

FIG. 2 depicts a top view of a hydroelectric power generator in accordance with one embodiment of the present invention. The hydroelectric power generator 200 generally comprises a continuous track 210, a plurality of fins 220, and a generator 230. The hydroelectric power generator 200 may further comprise a front nozzle structure 240 and a rear diffuser structure 250 for facilitating the flow of water into and out of the hydroelectric power generator 200. In addition, the hydroelectric power generator 200 may also optionally comprise a plurality of inlets 260 along sidewalls of the hydroelectric power generator 200 to allow additional water into the top channel to allow trailing fins to assist in the driving force behind the generator 230.

The front nozzle structure 240 may comprise any type of physical structure suitable for facilitating the flow of water into the hydroelectric power generator 200. Although termed a “nozzle,” it should be appreciated that any basic structure (e.g., nozzle, diffuser, or the like) may be suitable for embodiments of the present invention. In many embodiments, the function of the front nozzle structure 240 is to ensure the volume of water entering the hydroelectric power device 200 is flowing as laminar as possible prior to engaging the front fin. In other embodiments, the function of the front nozzle structure 240 is to provide a maximum volumetric water flow rate into the hydroelectric power device 200. As such, the front nozzle structure 240 may be any size, shape, length, etc., to facilitate desirable flow characteristics into the hydroelectric power generator 200.

In one embodiment, the front nozzle structure 240 is designed as a conical-type structure, terminating on a first end in a substantially apex shape. The second end of such structure may terminate at a point of intersection where the front fin is extended to its open, substantially 90 degree position. Acting as a nozzle, an increased force may be applied to the front fin as soon as it is in an accepting, open position.

The rear diffuser structure 250 may comprise any type of physical structure suitable for facilitating the flow of water out of the hydroelectric power generator 200 with minimal environmental impact. Although termed a “diffuser,” it should be appreciated that any basic structure (e.g., nozzle, diffuser, or the like) may be suitable for embodiments of the present invention.

In many embodiments, the function of the rear diffuser structure 250 may be to ensure the volume of water leaving the hydroelectric power device 200 is flowing as laminar as possible so as to not disturb marine life surrounding the hydroelectric power device. In other embodiments, the function of the rear diffuser structure is to direct the output volume of water in a different direction than it would normally have flowed, for example, where preservation of a particular environmental structure requires deflection of any direct current—natural or artificial. As such, the rear diffuser structure 250 may be any size, shape, length, etc., to facilitate desirable flow characteristics out of the hydroelectric power generator 200.

The optional plurality of inlets 260 along sidewalls of the hydroelectric power generator 200 may be provided to allow additional water into or out of the top channel of the hydroelectric power generator 200. Although the primary driving force of the hydroelectric power generator 200 is the front fin at any given instance, it may be desirable to maximize overall force on all fins to increase the rotational power driving the generator 230. By providing optional inlets 260, there may be increased volumetric flow into trailing fins 220, thus increasing the overall force applied to the fins 220.

In addition to the inlets 260, another means to increase the overall force applied to the fins 220 is to minimize the drag on each of the fins once the fin reaches a back side of the hydroelectric power generator 200 and begins to collapse to its closed, zero degree position. In accordance with embodiments of the present invention, the fins 220 may optionally be fitted with one or more release doors 224.

The release doors 224 may be pivotably affixed to the fins 220, pivoting toward the front surface of the fins 220. As a fin 220 moves around the backside of the hydroelectric power generator 200, the release doors naturally open in light of the force of the water, now on a back surface of the fin 220. By opening the release doors, the overall surface area of the back surface of the fin 220 is reduced, thus decreasing the drag force thereon.

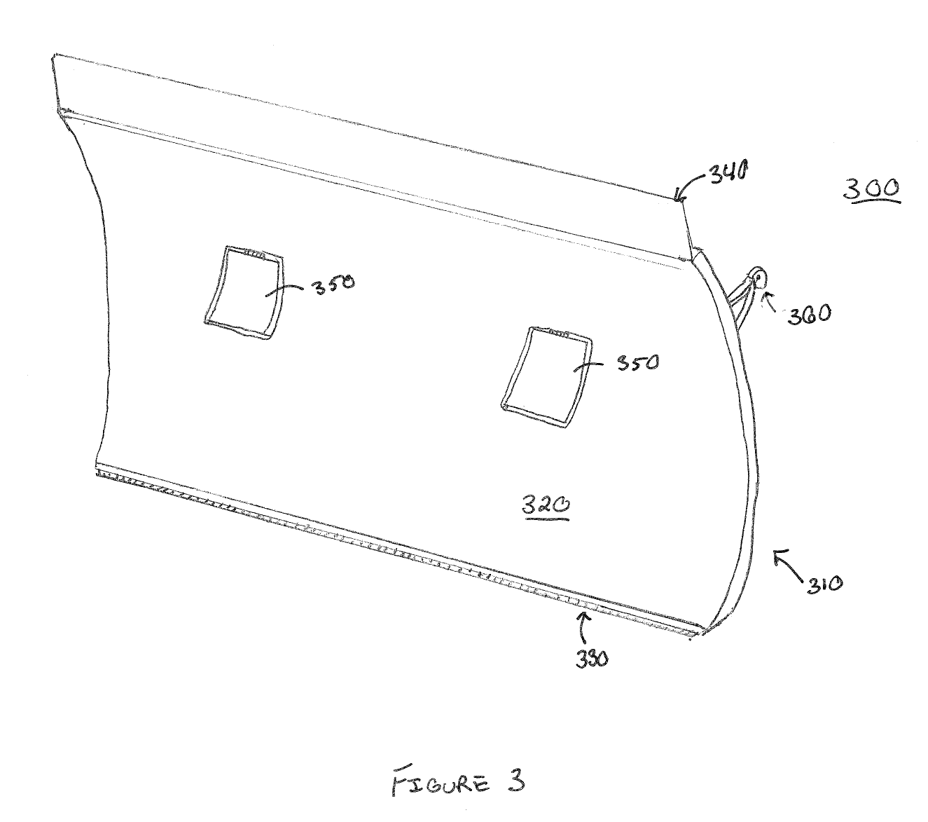

FIG. 3 depicts a perspective view of a fin for use in a submersible hydroelectric power generator in accordance with one embodiment of the present invention. A fin 300 generally comprises a substantially rigid member, having a front surface 320 for engaging a fluid when submersed in a source of continuously moving fluid. In many embodiments, the fin 300 is substantially rectangular having a height defined between a bottom edge 330 and a top edge 340, and a width measured between its two side edges. In many embodiments the fin 300 has a thickness that is substantially less than either the width or height, measured between the front surface 320 and the back surface 310 of the fin. In certain embodiments the fin 300 has a varying thickness, as determined to be suitable for embodiments of the present invention.

In some embodiments, the fin 300 comprises one or more release doors 350 as described above. The surface area of the front of the release doors 350 may comprise anywhere between about 10% to about 75% of the overall surface area of the front surface 320 of the fin 300. As explained above, the release doors 350 may be pivotably connected to the fin 300, such that the release doors 350 may facilitate the passage of water through the fin 300 when the water is acting on the back surface 310 of the fin 300. In alternative embodiments, the release door 350 may comprise a unidirectional permeable material, such that water may pass therethrough in one direction, but not in the other. Similarly, in other embodiments, the release door 350 may comprise a one-way valve to achieve the same function as described hereinabove.

In many embodiments of the present invention, the fin 300 is provided with a degree of concavity about its front surface 320, to enable the fin 300 to maximize drag force thereon when in position to engage a source of continuously flowing fluid, yet act as an airfoil, having minimal drag thereon when in a position to avoid restrictive forces. The degree of concavity of the fin 300, as measured about a mean camber line of the fin 300, may vary depending upon the commercial application of an embodiment of the present invention.

The bottom edge 330 of the fin 300 may generally comprise a pivotable means of engagement whereby the fin 300 may connect to or engage a continuous track (not shown), as described herein. Depending on the varying structure of the types of continuous tracks utilized with embodiments of the present invention, the pivotable means of engagement may comprise any suitable apparatus or structure. For example, in one embodiment, the pivotable means of engagement comprises a hinge, whereby one side of the hinge in connected to the fin 300 at the bottom edge 330, and the opposing side of the hinge is affixed to the continuous track. Further embodiments of the present invention appreciate any type of pivotable structure may be suitable for embodiments of the present invention.

In some embodiments of the present invention, an optional wheel support 360 may be provided to assist the fin 300 when passing around the backside and underside of a frame, as discussed herein, to engage a rail and ensure proper motion and positioning of the fin 300 in a closed position.

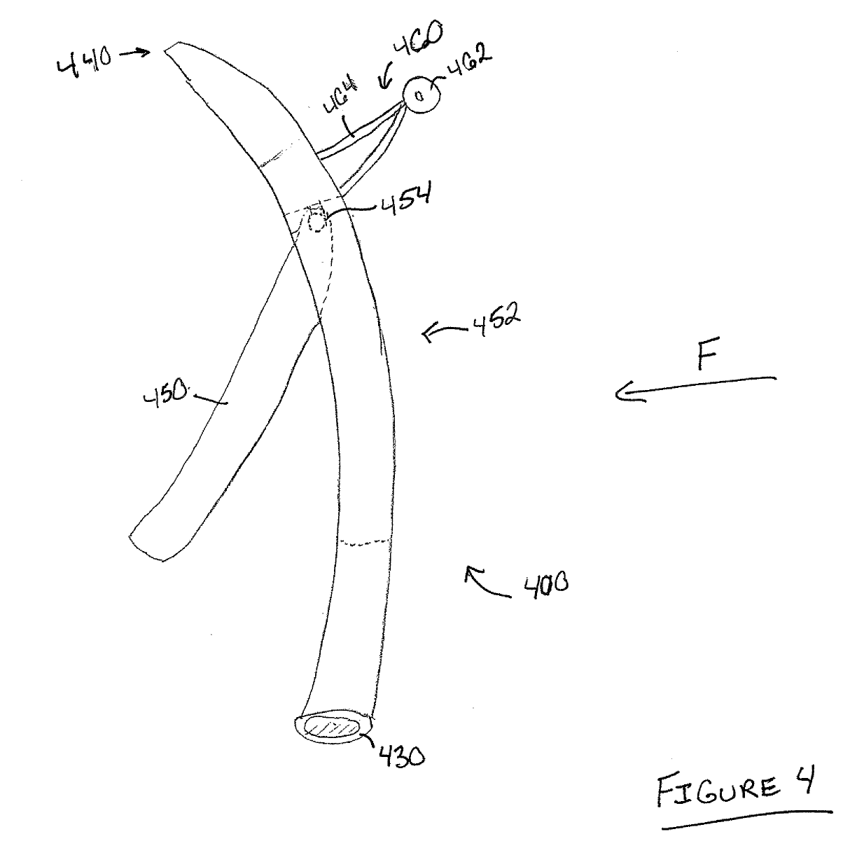

FIG. 4 depicts a side view of a fin for use in a submersible hydroelectric power generator in accordance with one embodiment of the present invention. Similar to FIG. 3, the fin 400 generally comprises a top edge 440 and a bottom edge 430. The fin 400 may also generally comprise at least one release door 450. As shown in the Figure, the release door 450 may swing to an open position about a hinge 454 when the back surface of the fin 400 is acted upon by a force F. In many embodiments, the force F is caused by a volume of water. As such, when the release door 450 is in an open position, the volume of water may pass through the space 452 in the fin 400. Similarly, when in an open position, the surface area of the back surface of the fin is greatly reduced, thus minimizing any forces acting thereon by water pressure. Although the release door 450 is shown as being pivotable along its edge closest to the top edge 440 of the fin 400, the release door 450 may be pivotable about any of its edges, as determined by the specific application of embodiments of the present invention. Similarly, the release door 450 may comprise substantially any shape feasible within the context of embodiments of the present invention to optimize performance thereof.

The fin 400 may also comprise the optional wheel support 460, as introduced above. In such embodiments, the wheel support 460 may comprise a single wheel 462 supported by a bracket structure 464 off the back surface of the fin 400. Although shown proximate the side edge of the fin 400, the wheel support 460 is generally aligned with the continuous track, which may not extend the entire width of the fin 400. In certain embodiments, two or more of the wheel supports 460 may be provided on the fin 400. Also, in alternative embodiments, similar structures (i.e., for providing similar function) may be utilized to assist the fin 400 achieve proper motion and positioning.

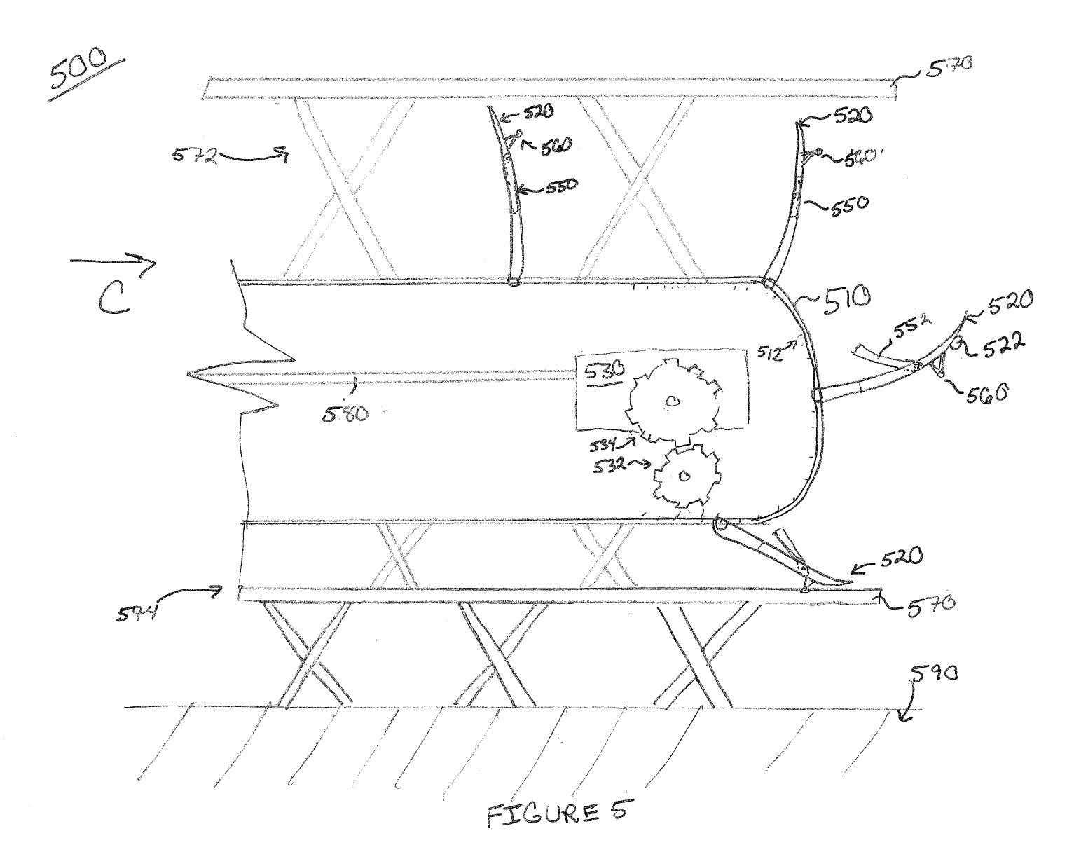

FIG. 5 depicts a side view of a hydroelectric power system in accordance with one embodiment of the present invention. In many embodiments, the hydroelectric power system 500 comprises a source of continuously moving water shown by its current C, a submersible hydroelectric power generator, and a power consumption entity (e.g., a building, a factory, a lighting fixture, a machine, a boat, a capacitive device, etc.) (not shown). In accordance with embodiments of the present invention, the submersible hydroelectric power generator generally comprises a frame structure 570 supporting a continuous track 510, a plurality of fins 520, each fin 520 rotatably connected to the track 510 about a bottom edge of the fin, a power generator 530 in communication with the track for converting rotational mechanical energy to electrical energy, and a power transmission line 580 (e.g., an industry-standard industrial power cable) for transmitting electrical energy to the power consumption entity.

The frame 570 of the submersible hydroelectric power generator generally comprises a top portion 572, a bottom portion 574, a front portion (not shown) positioned towards the source of the current C, and a rear portion opposing the front portion. The frame 570 may optionally be provided with a base mount or other tethering device to allow the hydroelectric power generator to rest on the floor 590 of the source of continuous water (e.g., a river bed floor, an ocean floor, etc.). It should be appreciated, although the front portion is described as being positioned towards the current C, the overall hydroelectric power generator may be positioned at a particular angle to the mean direction of the current C. That is, the current C may have a varying angle of attack with respect to the overall hydroelectric power generator.

Although not shown in the Figure, the frame 570 may also be provided with a housing or other protective and/or enclosing surfaces as may be needed to operate embodiments of the present invention. For example, in some embodiments, rather than leaving the entire hydroelectric power generator and its components open to flowing water, the interior of the device, i.e., within a volume defined by the continuous track 510, may be sealed by a housing. Often, the nature of the application of the system 500 will determine whether such housing is both feasible and/or necessary for optimal operation.

In many embodiments of the present invention, in operation, the plurality of fins 520 are in an open position when the fin 520 is passing along the continuous track 510 over a front and a top portion 572 of the frame structure 570, and the plurality of fins 520 are in a closed position when the fin 520 is passing along the continuous track 510 over a rear and bottom portion 574 of the frame structure 570. By operating in such a manner, the force created on the fins 520 in the open position (i.e., along the top portion 572 of the frame 570) by the current C is significantly greater than the force created on the fins 520 in the closed position (i.e., along the bottom portion 574 of the frame 570).

In some embodiments, the continuous track 510 comprises a means 512 for enabling the power generator 530 to receive rotational energy. As shown in the Figure, the means 512 may comprise a plurality of projections on an inside surface of the track 510. In such an embodiment, the projections may engage a primary gear 532, which subsequently engages a driving gear 534 of the power generator 530. In alternative embodiments, any structural arrangement for imparting rotational energy on a driving gear 534 of the power generator 530 may be utilized. For example, any gear, shaft, or track arrangement may be suitable for embodiments of the present invention.

As described supra, the fins 520 may comprise a release door 550, and a wheel support 560. The fins 520 may also comprise a floatation device 522, which assists the fins 520 to reach an open position when passing the front portion of the frame 570 and a closed position when passing the rear portion of the frame 570. As shown in the Figure, when passing the rear portion to the bottom portion 574 of the frame 570, the wheel support 560 of the fin 520 may engage the frame 570, or a portion thereof, and ensure the fin 520 remains in a closed position until it reaches the front portion of the frame 570.

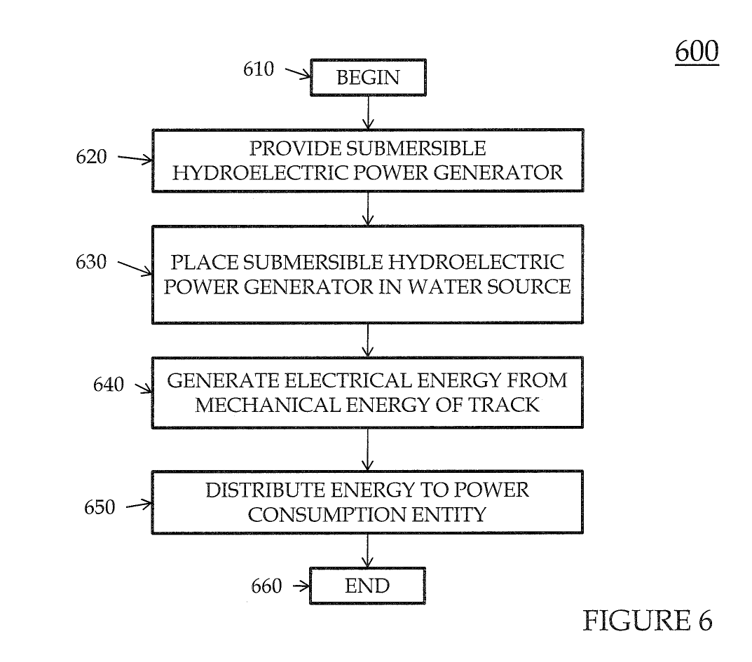

FIG. 6 depicts a flowchart of a method of generating hydroelectric energy in accordance with one exemplary embodiment of the present invention. The method 600 begins at step 610. At step 620, a submersible hydroelectric power generator, in accordance with one embodiment of the present invention, is provided. In such embodiment, the submersible hydroelectric power generator may comprise at least a frame structure supporting a continuous track, a plurality of fins, each fin rotatably connected to the track about a bottom edge of the fin, and a power generator in communication with the track for converting rotational mechanical energy to electrical energy.

At step 630, the submersible hydroelectric power generator is placed into a source of continuously moving water. For example, in one embodiment, the submersible hydroelectric power generator is placed within a river, a stream, an ocean or the like. In many embodiments, it may be beneficial to place the submersible hydroelectric power generator within a source of continuously moving water having predictable movement trends (e.g., an ocean having a predictable tide schedule, or a river having a known flow rate for specific times of year based on measured rainfall). Often, when placing the submersible hydroelectric power generator into the water, it is desirable to anchor, tether or otherwise affix the submersible hydroelectric power generator to a fixed or controllable object, such as the floor of water source, a barge, a buoy, or the like. Similarly, depending on the nature of the water source, it may be desirable to allow the submersible hydroelectric power generator to rotate about a vertical axis, to continuously face an oncoming current.

At step 640, electrical energy is generated from mechanical energy of the continuous track of the submersible hydroelectric power generator. As described hereinabove, because each of the plurality of fins are in an open position when the fin is passing along the continuous track over a front and a top portion of the frame structure, and because each of the plurality of fins are in a closed position when the fin is passing along the continuous track over a rear and bottom portion of the frame structure, a continuous “clockwise” motion is imparted to the track when the submersible hydroelectric power generator is submersed into the water. By utilizing any type of means for enabling the power generator to receive rotational energy described herein, the power generator is continuously receiving rotational mechanical energy. By virtue of the nature of the generator (e.g., an electromagnetic generator), electrical energy may be produced therein.

At step 650, such electrical energy may be distributed to a power consumption entity. In many embodiments, the power consumption entity exists above the surface of the water. Any type of structure, device, apparatus, etc., that can utilize electrical energy may be suitable for the power consumption entity. In certain embodiments, the power consumption entity may comprise a capacitive device (e.g., a battery), for storing electrical energy for future use. In such types of embodiments, energy generated by the submersible hydroelectric power generator may be utilized great distances away from the source of water.

The method 600 ends at step 660.

In accordance with alternative embodiments of the present invention, the submersible hydroelectric power generator may be modified and altered in numerous ways without departing from the scope and intent of the disclosed embodiments herein. For example, although disclosed in a substantially oval or rectangular shape, the overall frame and continuous track structure of the submersible hydroelectric power generator may comprise any suitable shape (e.g., circular, square, triangular, etc.) to yield optimal results for a particular application.

While the foregoing is directed to embodiments of the present invention, other and further embodiments of the invention may be devised without departing from the basic scope thereof.

What is claimed is:

1. A submersible hydroelectric power generator comprising:
a frame structure supporting a continuous track;
a plurality of fins, each fin rotatably connected to the track about a bottom edge of the fin;
a power generator in communication with the track, the power generator for converting rotational mechanical energy to electrical energy;
wherein each of the plurality of fins are in an open position when the fin is passing along the continuous track over a front and a top portion of the frame structure, and wherein each of the plurality of fins are in a closed position when the fin is passing along the continuous track over a rear and bottom portion of the frame structure.

2. The submersible hydroelectric power generator of claim 1, where each fin comprises a degree of concavity towards a front surface of the fin.

3. The submersible hydroelectric power generator of claim 1, wherein each fin comprises a release door for allowing a fluid to pass therethrough.

4. The submersible hydroelectric power generator of claim 3, wherein the release door is pivotably connected to the fin, and is capable of rotating towards a front surface of the fin.

5. The submersible hydroelectric power generator of claim 1, wherein each fin further comprises a wheel support, positioned on a back surface of the fin, for engaging a bottom portion of the frame structure.

6. The submersible hydroelectric power generator of claim 1, wherein each fin further comprises a floatation device positioned on a back surface of the fin.

7. The submersible hydroelectric power generator of claim 1, further comprising a means for enabling the power generator to receive rotational energy.

8. The submersible hydroelectric power generator of claim 7, wherein the means comprises a plurality of projections on an inside surface of the track.

9. A power system comprising:
a source of continuously moving water;
a submersible hydroelectric power generator comprising:
a frame structure supporting a continuous track;
a plurality of fins, each fin rotatably connected to the track about a bottom edge of the fin;
a power generator in communication with the track, the power generator for converting rotational mechanical energy to electrical energy;
wherein each of the plurality of fins are in an open position when the fin is passing along the continuous track over a front and a top portion of the frame structure, and wherein each of the plurality of fins are in a closed position when the fin is passing along the continuous track over a rear and bottom portion of the frame structure; and
a power consumption entity.

10. The power system of claim 9, wherein each fin comprises a release door for allowing a fluid to pass therethrough.

11. The power system of claim 10, wherein the release door is pivotably connected to the fin, and is capable of rotating towards a front surface of the fin.

12. The power system of claim 9, wherein each fin further comprises a wheel support, positioned on a back surface of the fin, for engaging a bottom portion of the frame structure.

13. The power system of claim 9, wherein each fin further comprises a floatation device positioned on a back surface of the fin.

14. The power system of claim 9, further comprising a means for enabling the power generator to receive rotational energy.

15. The power system of claim 14, wherein the means comprises a plurality of projections on an inside surface of the track.

16. The power system of claim 9, wherein the source of continuously moving water comprises one of a river, a stream, or an ocean.

17. The power system of claim 9, wherein the power consumption entity comprises one of a building, a factory, a lighting fixture, a machine, a boat, or a capacitive device.

18. A method of generating hydroelectric power comprising:
providing a submersible hydroelectric power generator, the submersible hydroelectric power generator comprising:
a frame structure supporting a continuous track;
a plurality of fins, each fin rotatably connected to the track about a bottom edge of the fin;
a power generator in communication with the track, the power generator for converting rotational mechanical energy to electrical energy;
wherein each of the plurality of fins are in an open position when the fin is passing along the continuous track over a front and a top portion of the frame structure, and wherein each of the plurality of fins are in a closed position when the fin is passing along the continuous track over a rear and bottom portion of the frame structure;
placing the submersible hydroelectric power generator in a source of continuously moving water, wherein the front of the frame structure is facing towards the direction of the continuously moving water;
generating electrical energy from the rotational mechanical energy of the track; and
distributing the electrical energy to a power consumption entity.

19. The method of generating hydroelectric power comprising of claim 18, wherein the source of continuously moving water comprises one of a river, a stream, or an ocean.

20. method of generating hydroelectric power comprising of claim 18, wherein the power consumption entity comprises one of a building, a factory, a lighting fixture, a machine, a boat, or a capacitive device.
